(19) United States
(12) Patent Application Publication
(10) Pub. No.: US 2013/0254491 A1
(43) Pub. Date: Sep. 26, 2013

(54) CONTROLLING A PROCESSOR CACHE USING A REAL-TIME ATTRIBUTE

(71) Applicants: James A. Coleman, Mesa, AZ (US); Durgesh Srivastava, Cupertino, CA (US)

(72) Inventors: James A. Coleman, Mesa, AZ (US); Durgesh Srivastava, Cupertino, CA (US)

(21) Appl. No.: 13/993,052

(22) PCT Filed: Dec. 22, 2011
(86) PCT No.: PCT/US11/66973

§ 371 Date: Jun. 10, 2013

(51) Int. Cl. G06F 12/12

(52) U.S. Cl. CPC G06F 12/123
USPC 711/133

(57) ABSTRACT

A processor device has a cache, and a cache controller that manages the replacement of a number of cache lines in the cache, in accordance with a replacement policy. A storage location is to be configured to define a memory map having a cacheable region, an un-cacheable region, and a real time region. Upon a cache miss of an address that lies in the real time region, the cache controller responds by loading content at the address into a cache line, and then prevents the cache line from aging as would a cache line that is in the cacheable region. Other embodiments are also described and claimed.

### FIELD OF THE INVENTION

This disclosure relates to integrated circuit processor devices and, in particular, to techniques for improving the performance of a real-time program running on the processor device. Other aspects are also described.

### BACKGROUND

A real-time program is a computer program that needs to guarantee a response within strict time constraints. Examples include those running in industrial control systems, video games, and medical devices, to name just a few. The processor device on which a real time program is to run may need to guarantee a maximum latency (or time delay) when executing certain portions of the program. For instance, the program may require that a maximum interrupt latency be no more than a specified time interval. Interrupt latency is the time from when a peripheral device requests servicing by the processor device, to when the processor begins execution of an interrupt service routine for the peripheral device.

The peripheral device may, for example, be a sensor that has suddenly detected a particular condition and is therefore requesting that the processor device analyze its signal, pursuant to instructions in the program.

Typically, processor devices that are used in consumer electronic devices such as desktop computers and laptop computers have not been optimized to meet the latency requirements of real time programs. Most processor devices have a cache that can significantly speed up the performance of many programs, by keeping frequently used portions of a program in a fast yet small storage area. However, the limited and shared nature of the cache inevitably results in cache misses, which slow down the program and may also cause substantial performance differences between different runs of the same program. These may be unacceptable to designers of embedded systems that run real time programs.

This has made it at times a difficult choice to embed a processor device that is traditionally designed for a desktop or laptop computer into a computer system that runs a real-time program or application (which typically requires strict guarantees of latency for certain portions of it).

To improve the predictability of running a program so that it meets a certain maximum period of time for execution, as well as maintaining the results of the execution uniform (in terms of how long it takes to execute one run and then another run), several approaches have been taken. One approach is to compute the expected execution time of the program, in order to verify that it meets the latency requirement. That approach, however, has proven to be fraught with significant inaccuracy particularly where the program is relatively complex, for instance, having multiple tasks executing concurrently or in parallel, and sharing the same cache.

Another approach is to simply disable the cache, when the desired program is to run, thereby rendering greater predictability to the calculations of the execution times. Doing so, however, does significantly reduce the performance of the program, in some cases to unacceptably low levels. An approach taken in multi-threaded, multi-core systems is to use a prioritized cache that gives priority to instructions of real-time threads, while allowing all threads to share an aggregate cache space. Under that approach, threads running on different processing cores of the device are assigned different priorities by the operating system. In other words, a thread with a lower priority cannot replace the data or instructions of a higher priority thread, while a thread with higher priority can evict the data or instructions of a low priority thread. To achieve this result, a priority bit is added to each cache line, which is used to differentiate the priorities of threads from different cores. At the time of each cache line replacement, the priority bit will be set based on the priority of the thread that accesses it.

In another approach, each cache line has an attribute that allows it to be either locked or released. When a cache line is locked, its data should not be replaced (when a cache miss occurs). If the attribute of the cache line is then changed to “released”, then its data becomes replaceable as in a conventional cache replacement policy. A cache controller is allowed to lock or release a given cache line, in response to certain processor instructions. Such instructions may extend the conventional load/store from main memory operation, by also either locking or releasing in each case, the resulting cache line. For the programmer using such a construct, data that is to be accessed frequently should be locked in the cache.

It should also be noted that the cache locking scheme requires that the cache be preloaded with the desired portions of the program and then locked, prior to normal execution or run time of the program.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a block diagram of a processor device suitable for addressing the latency requirements of real-time programs.

FIG. 2A, 2B are flow diagrams of methods for controlling a processor cache when executing latency sensitive yet infrequently used program portions.

FIG. 3 is a block diagram of a computer system.

FIG. 4 shows how a CPU control register has been configured by a program, to define various regions in physical memory including a real-time region containing an interrupt service routine.

### DETAILED DESCRIPTION

Several embodiments of the invention with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

As explained above in the Background section, in processor devices (also referred to here as central processing units, CPUs) that are not primarily intended for real-time embedded system applications, the delay or latency to begin executing certain portions of a program, such as an interrupt service routine, is not uniform across various runs of the program, but rather can vary substantially depending upon factors such as CPU state and the state of a CPU cache. An embodiment of the invention is a processor device that may keep latency sensitive yet infrequently used portions of a program (also referred to as data and code) in the cache, so as to provide the programmer with a better guarantee on the number of CPU clock cycles from the time when the processor device receives an interrupt to when the processor device executes the associated interrupt service routine. Another embodiment is a method of operating or controlling a processor cache so as to ensure that latency sensitive code and data of a program are maintained in the CPU cache, thereby reducing the occurrence of cache misses that may otherwise occur during run time. Operating the cache in this manner thus allows the processor device more flexibility to run a real-time application.

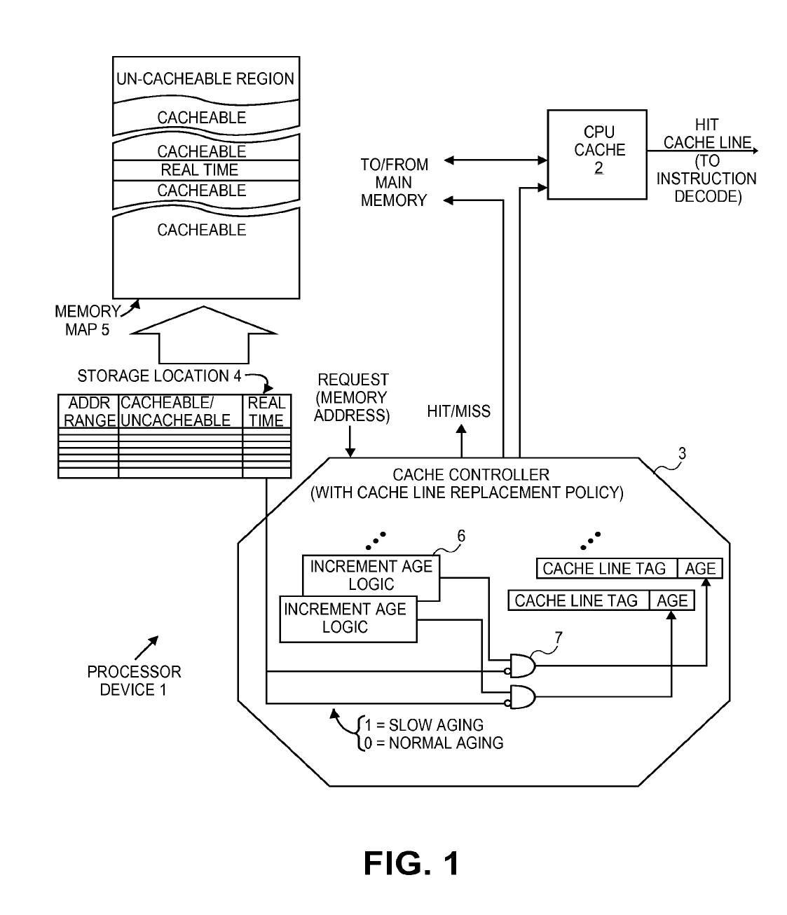

FIG. 1 shows a block diagram of a processor device 1 that is suitable for addressing the latency requirements of real-time programs. The processor device 1 may be a general-purpose microprocessor, a digital signal processor, a microcontroller, a multi-core processor, or a system on a chip (SoC), whether as a single chip package or in a multi-chip module. It has a CPU cache 2 to which a cache controller 3 is coupled. The cache controller 3 manages the replacement of cache lines in the cache 2 in accordance with a scheme in which a weight is given to a relevant cache line, where this weight is then used to select which cache lines are evicted. The weight changes over time and as a result of cache access patterns. Examples of such cache replacement policies include a Least Recently Used (LRU) replacement policy, and a pseudo LRU replacement policy. Each of the cache lines may have an associated age indicator that is associated with a cache line tag as shown. The age indicator may be a counter that is incremented by the cache controller 3 in accordance with the particular replacement policy, for instance each time there is an access request (e.g., read or write to a memory address or location) that may or may not result in a hit to another cache line. A cache line is thus said to age, as the other cache lines are accessed. In one embodiment, the LRU or pseudo LRU policy operates to invalidate or evict from the cache the least recently used items first, namely the oldest cache line. In one instance, every time a cache line is used, that is when an access request results in a hit on a cache line, the age of all other cache lines may be incremented. Other caching algorithms that may include variations to the basic scheme described here are possible.

The processor device 1 also has a storage location 4 that is to be configured to define a memory map 5 having at least the following address regions: an uncacheable region, a cacheable region, and a real-time region. These regions may be defined, for example by an author of a program that will be running on the processor device 1, as address ranges in physical memory that have the following characteristics (which characteristics are then implemented by the cache controller 3). The cacheable region may include portions of the program that are expected to be accessed frequently, relative to program regions that are not likely to be accessed frequently. The latter may be allocated to the uncacheable region. The cache controller 3 upon receiving a request checks the storage location 4 to determine whether the requested address lies within a cacheable region and if so places a copy of the content at that address into the cache 2. If however the address lies in the uncacheable region, then the content is not copied to the cache 2.

In accordance with an embodiment of the invention, the storage location 4 is to also define a real-time region (for which a real-time attribute associated with a specified address range has been asserted). Upon a cache miss of an address that lies in the real-time region (as checked by the cache controller 3), the cache controller 3 responds by loading content at the address into a cache line.

Thereafter (e.g., when receiving a subsequent request that results in a hit on another cache line), the controller 3 slows the rate at which the “real-time” cache line ages. This slowed aging rate can be anywhere from normal aging up to and including no aging. Thus, the real-time cache line is prevented from aging as would a “non real-time” or standard cache line (i.e., located in a cacheable region as defined in the storage location 4). In other words, a real-time cache line would not age as a standard cache line, but rather would appear as a recently fetched or recently accessed line, regardless of the actual age of the line. This results in the latency sensitive code and data (that has been mapped to the real-time region) remaining in the cache 2 long enough so as to reduce (or perhaps even eliminate) the indeterminate delay of cache misses that would otherwise be suffered by the program, during run time. This may enable the processor device 1 to more effectively run real-time applications. Note that this technique is quite different from a conventional cache locking scheme, where the latency sensitive portion of a program is preloaded into one or more cache lines which are then marked as being locked, prior to the normal or run time execution of the program.

As explained above, when the cache controller 3 receives a read request for a memory address that happens to be in the cacheable region (as it is defined in the storage location 4), but that results in a cache miss, the controller 3 will respond by reading the content at the requested address (e.g., from a backing storage, generically referred to here as “main memory”), and then writing the read content into a new cache line of the cache 2. On the other hand, if the read request is for a memory address that lies in the uncacheable region (and that also results in a cache miss), then the controller 3 may respond by reading the content at the requested address but then does not write the content into the cache 2. In the case where the request is a write, the write to the cache may be in accordance with any one of several known policies; the policy to use for the cacheable region (and perhaps also for the real time region) may have been configured in the storage location 4, e.g. as any one of write through, write combine, write protect, and write back.

Still referring to FIG. 1, when the cache controller receives a request for content at a given memory address, it may respond by checking the cache line tags of the CPU cache 2, looking for the requested memory address. If present, then a hit signal is asserted and the hit cache line is then provided by the CPU cache 2 to the instruction processing logic (not shown) of the processor device 1. On the other hand, if the requested memory address is not present in the CPU cache 2, then a miss signal is asserted and the cache controller 3 will then fetch the requested content at the memory address and will then store the content in an entry (cache line) of the cache 2, provided of course that the requested memory address lies in either a cacheable region or a real time region (as indicated in the storage location 4).

The cache controller 3 has increment age logic 6 whose output signals the associated age indicator of a cache line to be incremented, for instance in accordance with a default replacement policy (e.g., pseudo LRU). However, as seen in FIG. 1, the output of the increment age logic 6 is qualified by the associated real time attribute (obtained from the storage location 4), in this example by way of an AND logic gate 7. When a real attribute bit is asserted (in this case, as logic 1), the output of the increment age logic 6 is prevented from incrementing the associated age indicator. In other words, the age indicator of a cache line is not incremented when its associated real time attribute is asserted, and so the cache line does not age in the same way as the normal or default cache line replacement scheme. In one embodiment, for each entry in the storage location 4, the real time attribute has a single binary bit that indicates either slow aging (which may include ageless) or normal aging. Ageless means that a cache line, which lies in the real time region indicated in the storage location 4, always appears as a newly fetched or newly accessed (e.g., recently hit) cache line; this forces another (normal aging) cache line to be evicted even if the another cache line had been used more recently than the real time (now ageless) cache line. Slow aging may alternatively mean that the cache line does in fact age (its age indicator can be incremented, such that it can eventually be evicted if it is not accessed frequently enough). However, the real time cache line in this case will age more slowly than another (normal aging) cache line. For example, its age indicator will be incremented every two, three, four, etc. accesses to the cache 2, while the age indicator of a normal aging cache line will be incremented after each and every access. In another embodiment, the real time attribute has even more granularity, e.g. at least two binary bits that indicate any one of more than two different aging levels, e.g. ageless, aging at a low rate, and aging at a high rate.

The storage location 4 may be a register that defines the memory map 5, for instance in physical address space. In that case, the CPU cache 2 would in many instances be a Level 1 instruction or data cache, or it could be a Level 2 cache (in the case of a multi-level cache). As an alternative, the storage location 4 could define the memory map 5 in the virtual address space, and the CPU cache 2 would be a higher level cache, a translation lookaside buffer or perhaps a page attribute table. In most instances, the storage location 4 includes several entries, where each entry has an address range, an associated cacheable or uncacheable attribute, and a real-time attribute. For example, a portion of a program that is expected to be latency sensitive, yet infrequently used, may be identified by its address range and marked in the storage location 4 as being cacheable (e.g., at least one bit being asserted), and real-time (e.g., at least one other bit being asserted). The address range itself could be identified by one or more words. Configuring the storage location 4 would result in the memory map 5 being defined and implemented by the cache controller 3 when it responds to incoming access requests. It is expected that a provider of software for the processor device 1, for example a provider has developed a real-time or embedded system of which the processor device 1 will be a part, may add the needed processor code and data for configuring the storage location 4, into its real time program which may also contain the latency sensitive section of code and data that is to be given preferential treatment in the replacement policy cache eviction scheme (by being labeled as a real time region).

The storage location 4 is part of a control mechanism that provides software running in the processor device 1 with control of how accesses to memory ranges in the main memory are cached. Examples include a memory-type range register, an address range register, another architectural register, a renamed physical register, or even a buffer that has been allocated in main memory. Note that the term “register” as used here means at least one register unit, and may refer to, for instance, an array of or multiple register units, such as a register file. In many instances, the storage location 4 would be a CPU control register that is on chip with the cache controller 3 for fast access. The storage location 4 may be one that can be configured by system software such as firmware (e.g., basic I/O system (BIOS), extensible firmware interface (EFI), and an operating system device driver; a utility program; a user application program; and a development tool (e.g., a compiler, linker, or debugger).

The CPU cache 2 in a generic sense refers to any type of memory in an integrated circuit processor device that is used to quicken the performance or execution of a program, by temporarily storing frequently used instructions, data and/or memory addresses in a fast, relatively small, and typically on-chip, storage location. Examples include instruction and data caches such as Level 1 or Level 2 caches, shared caches (shared by multiple processing cores of the processor device), translation lookaside buffers for virtual to physical memory address translations, and page attribute tables. In addition, the cache entry structure may vary but in most cases will include at least a cache line tag which may contain in some cases only the most significant bits of an associated memory address and additional entries including, for instance, an index and a displacement entry that help further identify the actual location in cache memory where the cache line or data block is being stored. The cache line may also have a valid bit, which denotes that it has valid data. Finally, it should also be noted that the replacement policy of the cache also decides where in cache memory, that is in which entry, a copy of a particular entry from main memory will be stored. In a fully associative cache, the replacement policy is free to choose any entry in the cache to hold the copy. At the other extreme, each entry in main memory can be stored in just one place in the cache—this is referred to direct mapped. May caches implement a compromise in which each entry in main memory can go to any one of N places in the cache—these are described as N-way set associative.

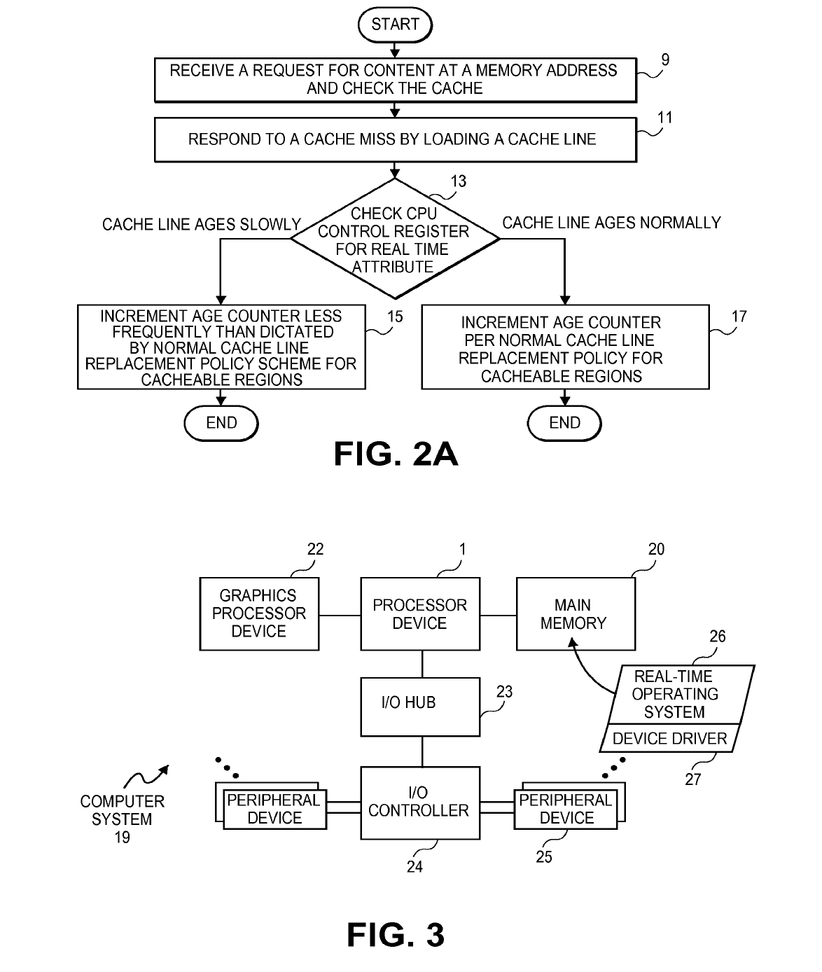

Turning now to FIG. 2A, a flow diagram of a method for controlling a processor cache when executing latency sensitive yet infrequently used program portions is shown. The operations described here may be performed by the cache controller 3 (see FIG. 1) which may be implemented as dedicated hardwired logic, a state machine, a programmed controller, or any suitable combination. The process starts with an access request being received, for content at a specified address (e.g., a physical memory address produced by a program counter—not shown). In response, a CPU cache is checked for the requested address (block 9). The CPU cache may be one that is managed in accordance with an LRU or pseudo LRU replacement policy. Either a cache hit or a cache miss for the memory address is generated.

In the event of a cache miss, the process continues by responding to the cache miss and loading content at the memory address into a cache line (block 11). In the case of a read request, the fetched content is provided to the instruction decode and execution logic (not shown). In the case of a write request, where the cache look up resulted in a miss, a read for ownership (RFO) may occur, brining the original contents of the line to be written into the cache. After the RFO, or in the case of a cache hit, the content of the write request is written into the cache line, in accordance with the write policy of that region of memory e.g., a write through or a write back policy. Other cache coherence protocols are possible.

Now, in the event of a cache miss, the process also continues by checking a CPU control register (e.g., a memory map register, such as a memory type range register, MTRR, or a an address range register, ARR) for an attribute (block 13). In other words, a lookup of the requested memory address is performed, which produces an attribute that is associated with the memory address. If the produced attribute is a real time attribute that is asserted (meaning slow aging, which may encompass ageless, as well aging but at a lower rate than normal), then the process continues with aging the cache line slowly, i.e. its age counter is incremented less frequently (including not at all) than would be dictated by a normal replacement scheme for a cacheable region (block 15). In other words, the cache line is prevented from aging normally (in accordance with a normal replacement policy). If the real time attribute is not asserted, then the process continues with aging the cache line “normally”, i.e. its age counter is incremented per the normal or default replacement scheme (block 17).

The operations in blocks 15, 17 may be viewed as marking the cache line with an aging indicator that is based on the real time attribute, wherein the marked aging indicator is in this case either a slow aging indicator or a normal aging indicator; in response to marking with the slow aging indicator, the cache line is prevented from aging as would another cache line that is marked with the normal aging indicator. Note that other attributes may be produced as well upon a lookup of the memory address, such as “cacheable” and “un-cacheable” (as described above). The cache line is marked with the slow aging indicator when the attribute is “real time”, and with the normal aging indicator when the attribute is “cacheable.”

Note that as explained above, the reference to “slow aging” may mean that the cache line is prevented from aging at all. In other words, in the case of a binary choice between slow aging and normal aging, slow aging may encompass “ageless” where the cache line would always appear as a newly fetched or newly accessed cache line, to the replacement policy, even though it is actually not.

FIG. 2B is a flow diagram of a process for controlling a processor cache, showing additional detail. The process begins with a receiving a request for content at a memory address (operation 10) and checking whether or not the content is in the cache (operation 12). If yes, then the requested content is returned (operation 14), and the accessed cache line containing the content is updated as being “recently used” (operation 16), following which the process ends. If not, then the process continues with fetching the requested content from memory (operation 18) and checking whether or not the memory location (from which the content is fetched) is cacheable (operation 21). If not, then the requested content is returned (operation 33), following which the process ends. If yes, then the requested content is still returned (operation 28), but then a copy of it is also stored in the cache (operation 29) and the newly stored content is updated as recently used (operation 30). The process then continues with checking whether or not the memory location (from which the content was fetched in operation 18) is “real time” (operation 31). If not, then the process ends. If yes, then the process continues with thereafter (as time passes and the cache continues to be accessed) incrementing the age counter (of the content that is newly stored in the cache in operation 29) less frequently than dictated by the default or normal cache replacement scheme (operation 32).

It should be noted that the actual order of occurrence of some of the depicted operations of the flow diagrams in FIG. 2A and FIG. 2B may be different than what is shown in the figures. For instance, while the flow diagram in FIG. 2B shows the box for operation 31 (checking whether or not the memory location is real time) as being reached after the box for operation 21 (checking whether or note the memory location is cacheable), it is possible that the two operations 21, 31 may be performed essentially simultaneously when first looking up the memory location in a CPU control register.

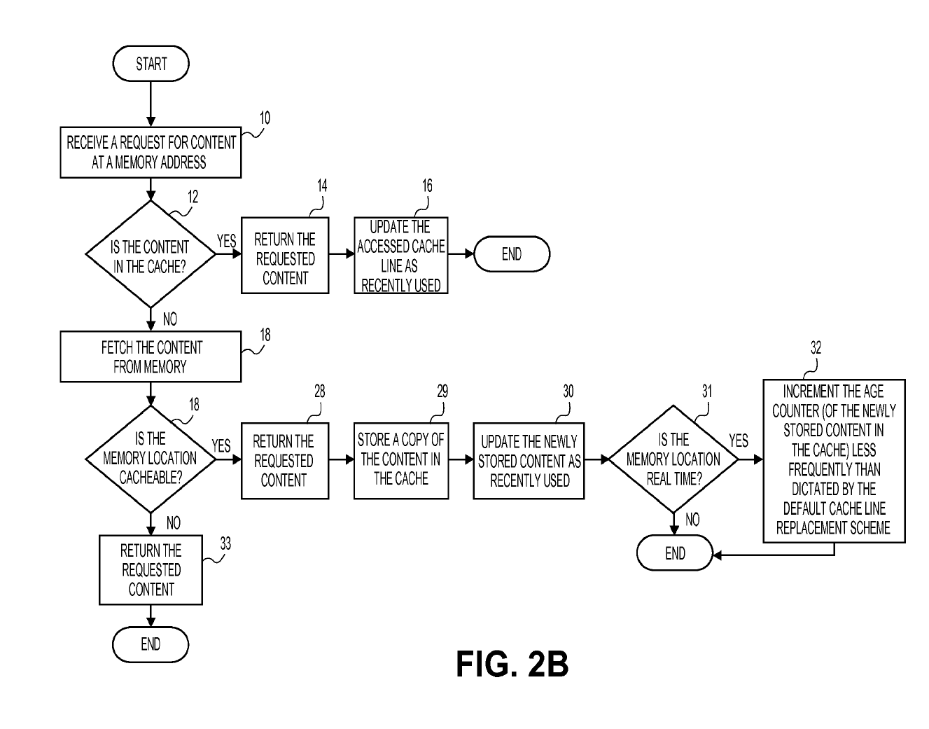

FIG. 3 is a block diagram of a computer system of which the above-described CPU cache control mechanisms may be a part. The computer system may be part of an embedded system, e.g. a medical system, an industrial automation system, an air traffic control system. Alternatively, it may be a general purpose computer such as a desktop computer or a laptop computer, a server, a communications router or switch, a smart phone, and a tablet computer. The computer system has main memory 20 in which programs are stored, such as an operating system 26, a device driver 27, and an application program (not shown). The operating system 26 may be a real time operating system. The main memory 20 may be composed of, for instance, static random access memory (RAM) or dynamic RAM. The processor device 1 may be as described above in FIG. 1, namely having a CPU cache coupled to the main memory 20, and a cache controller coupled to manage the replacement of a number of cache lines in accordance with a cache line replacement policy. The computer system also has storage (or a storage location) 4 that is to be configured by a program in the main memory 20, while the program is being executed by the processor device, to define a memory map having a cacheable region, an un-cacheable region, and a real time region. The storage location 4 may be a CPU control register that may be on-chip with the cache controller of the processor device 1. The storage location 4 may be configured during normal execution of the program, i.e. during run-time. Upon a cache miss of an address that lies in the real time region, the cache controller is to respond by loading content at the address into a cache line and wherein the loaded cache line then ages more slowly than a cache line that is in the cacheable region.

In one embodiment, the program is the device driver 27 and the cacheable, uncacheable, and real time regions are configured, by the device driver 27 (writing to the storage location 4—see FIG. 1), only when the device driver 27 is being executed in its usual course and by the action of code and data that is part of the device driver. In one instance, the configured real time region may include an interrupt service routine of the device driver 27, as well as an interrupt handler routine (e.g., as part of the operating system 26). These are examples of code and data that are typically used infrequently but are latency sensitive, and as such should be placed (by an author of the device driver 27) in a real time region, by appropriately configuring the storage location 4.

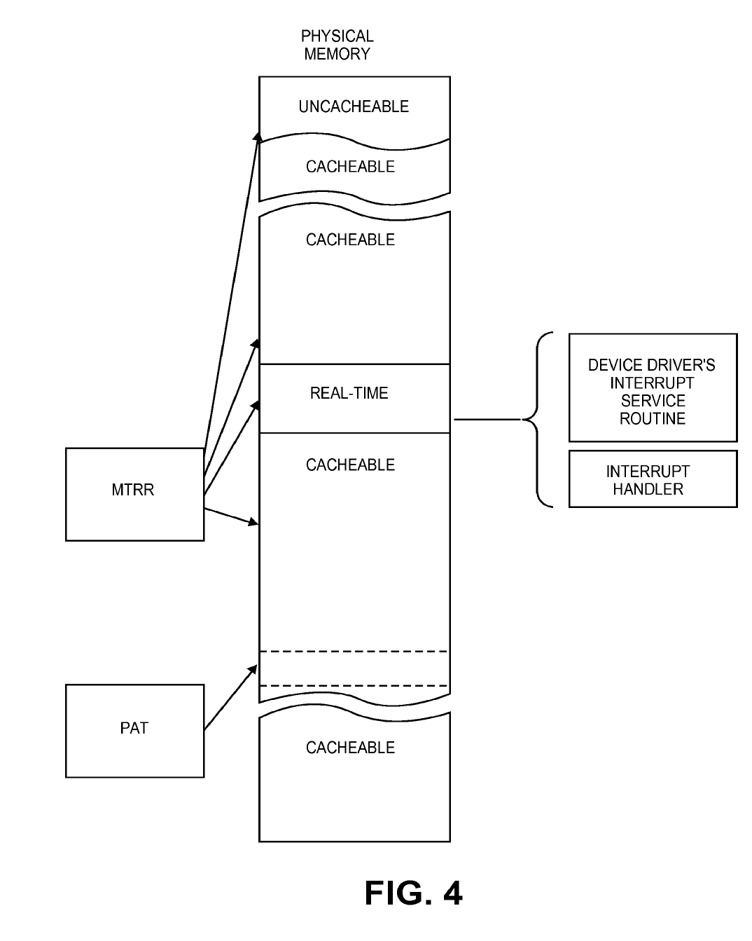

Referring now to FIG. 4, this figure shows how a CPU control register has been configured by a program, to define various regions in physical memory, including a real-time region containing an interrupt service routine that is part of that program. The register in this case is an MTRR that points to the different regions of the memory map, as it has been configured by the program. The real-time region contains a device driver's interrupt service routine as well as an interrupt handler routine (which may be part of microcontroller firmware, operating system, or the device driver). The interrupt handler may be a first level handler that may be platform dependent (specific to the particular type of processor device in which it is running) and that is automatically loaded when there is a context switch, upon the occurrence of an interrupt. The first level handler schedules the execution of a second level handler, which may be the interrupt service routine, which is a longer running routine that may also be used to perform platform independent tasks.

FIG. 4 also shows another embodiment of the invention, wherein the CPU control register is a modified page attribute table (PAT). The PAT like the MTRR allows fine grain control of how certain areas of memory are cached. However, while in some cases the MTRR may be limited to a fixed number of physical address ranges, the PAT may specify caching behavior on a per-page basis.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, while the processor device was described as running a portion of a program (located in the real time region) being an interrupt service routine of a device driver, other programs that may be deemed real-time applications (or that have real-time application characteristics) can also benefit from executing on such a processor device. Also, the techniques described above may work with a pseudo-LRU policy where in that case the replacement policy almost always discards one of the least recently used items, and with a segmented LRU architecture where the cache is divided into at least two segments, including a protected segment and a probationary segment. The description is thus to be regarded as illustrative instead of limiting.

What is claimed is:

1. A processor device comprising:
a cache;
a cache controller coupled to the cache to manage the replacement of a plurality of cache lines in the cache, in accordance with a replacement policy in which each of the cache lines has an associated age indicator; and
a storage location that is to be configured to define a memory map having a cacheable region, an un-cacheable region, and a real time region, wherein upon a cache miss of an address that lies in the real time region, the cache controller is to respond by loading content at said address into a cache line and then prevent the cache line from aging as would a cache line that is in the cacheable region.

2. The processor device of claim 1 wherein the storage location comprises a register that defines the memory map in physical address space.

3. The processor device of claim 1 wherein the storage location is to be configured to define the cacheable region as one of the group consisting of: write through, write combine, write protect, and write back.

4. The processor device of claim 1 wherein the storage location comprises a plurality of entries, each entry having an address range, an associated cacheable/un-cacheable attribute, and an associated real time attribute.

5. The processor device of claim 3 wherein the storage location comprises a plurality of entries, each entry having an address range, an associated cacheable/un-cacheable attribute, and an associated real time attribute.

6. The processor device of claim 4 wherein the cache controller comprises increment age logic that has an output which indicates that the associated age indicator of a cache line is to be incremented, in accordance with the replacement policy, and wherein the output of the increment age logic is qualified by the associated real time attribute.

7. The processor device of claim 4 wherein for each entry in the storage location, the real time attribute comprises a plurality of bits which can indicate any one of the group consisting of: ageless, low rate aging, and high rate aging.

8. The processor device of claim 4 wherein the associated real time attribute indicates one of slow aging and normal aging.

9. The processor device of claim 6 wherein the associated real time attribute indicates one of slow aging and normal aging.

10. A method for controlling a processor cache, comprising:
receiving a request for content at a memory address, and in response accessing a processor cache that has a replacement policy, to generate one of a cache hit and a cache miss for the memory address;
in response to the cache miss, loading content at the memory address into a cache line;
performing a lookup of the memory address to produce an attribute that is associated with the memory address;
marking the cache line with an aging indicator that is based on the attribute, wherein the marked aging indicator is one of a slow aging indicator and a normal aging indicator; and
in response to marking with the slow aging indicator, preventing the cache line from aging as would another cache line that is marked with the normal aging indicator.

11. The method of claim 10 wherein the produced attribute, that is associated with the memory address, is one of cacheable, un-cacheable and real time.

12. The method of claim 11 wherein the cache line is marked with the slow aging indicator when the attribute is real time, and with the normal aging indicator when the attribute is cacheable.

13. The method of claim 11 wherein when marked with the slow aging indicator, the cache line is prevented from aging at all.

14. The method of claim 11 wherein the memory address is a physical memory address.

15. The method of claim 11 wherein preventing the cache line from aging comprises:
incrementing an age counter associated with said another cache line, in accordance with the replacement policy; and
preventing an age counter associated with said cache line from being incremented in accordance with the replacement policy, while marked with the slow aging indicator.

16. A computer system comprising:
main memory having stored therein a program; and
a processor device having a cache coupled to the main memory, a cache controller coupled to the cache to manage the replacement of a plurality of cache lines in the cache, in accordance with a replacement policy, and storage that is to be configured by the program while being executed by the processor device to define a memory map having a cacheable region, an un-cacheable region, and a real time region, wherein upon a cache miss of an address that lies in the real time region, the cache controller is to respond by loading content at said address into a cache line and wherein the loaded cache line ages more slowly than a cache line that is in the cacheable region.

17. The computer system of claim 16 wherein the storage is to be configured by the program to define the real time region as including an interrupt service routine.

18. The computer system of claim 17 wherein the storage is to be configured to define the real time region as further including an interrupt handling routine.

19. An article of manufacture comprising:
a machine-readable storage medium having stored therein a program that when executed by a processor device configures a control register of the processor device to define a real time region in a memory map for the processor device, wherein the memory map can also have a cacheable region and an un-cacheable region defined in the control register, and wherein the real time region contains code and data of an interrupt service routine that is part of the program.

20. The article of manufacture of claim 19 wherein the real time region further includes code and data of an interrupt handler routine.

21. The article of manufacture of claim 19 wherein the program is a device driver.

22. The article of manufacture of claim 19 wherein the program is an operating system program
